(19) United States
(12) Patent Application Publication
(10) Pub. No.: US 2005/0161525 A1
(43) Pub. Date: Jul. 28, 2005

(54) Device at a nozzle for regulation of gas or fluid

(76) Inventor: Per Johansson, Angelholm (SE)

Correspondence Address: MCGINN & GIBB, PLLC, 8321 OLD COURTHOUSE ROAD, SUITE 200, VIENNA, VA, 22182-3817, US

(21) Appl. No.: 10/510,566

(22) PCT Filed: Apr. 9, 2003
(86) PCT No.: PCT/SE03/00578

(30) Foreign Application Priority Data
Apr. 11, 2002 (SE) 0201122-9

(51) Int. Cl. A01G 27/00

(52) U.S. Cl. 239/68; 239/74; 239/418

(57) ABSTRACT

The present invention relates to a device in a nozzle for monitoring and/or regulating gas or liquid occurring in one or more ducts in a nozzle, or a mixture of one or more gases and/or one or more liquids, e.g., air and paint in a spraygun for a painting plant, a pressure indicator being mounted in the proximity of the end of that duct in the nozzle which is intended for the gas or liquid or mixture which is to be monitored and/or regulated, and is connected to an electric circuit for generating a signal corresponding to the pressure prevailing in the duct, and the electronic circuit being connected to a circuit for regulating one or more valves for adjusting the measured pressure to a desired norm value.

The present invention relates to a device according to the preamble to appended claim 1.

In such industrial processes as, for example, welding or painting, &here is a growing need for controlling and monitoring for better results and less effect on the environment, and it is or major importance that the absolutely correct quantity of gas or paint exits through the nozzle or nozzles. An increasing number of such operations is carried out with the aid of unmanned robots and this naturally requires continuous monitoring. In prior art installations, it has hitherto been necessary to operate with considerable safety margins, which entails increased costs, poor results and greater effects on the environment. There is thus a great need in the art to refine the measurement technique for saving considerable sums and reducing effects on the environment. Then are a large number of processes suffering from similar problems in which there are required exact mixtures between different gases and/or liquids. By way of example, mention might be made of anaesthetics gases in air or the admixture of plant nutrient gases in greenhouses. In, for example, gas welding, it is of major importance to have the correct mixture between oxygen and combustible gas in order that the welding results do not change the working properties and mechanical strength of the workpiece. Similarly, it may be possible to reduce the quantity of safety gas in other welding methods. In painting, it is naturally desirable to reduce waste material and at the same time ensure a satisfactory painting result. When, for example, a paint spraygun is aimed in different directions and hoses and other inlet conduits have different angles, there will occur pressure differences at the actual work point in relation to the placing or positioning of the valves. The valves cannot often be placed at the nozzle proper because of lack of space. It is further necessary to provide for a certain pivoting time from the commencement of the spraying operation until the process is stable. In a painting process, the drawback resides not only in the paint which is lost because it is sprayed outside the workpiece during a pivotal cycle, but to an even greater extent when parts must be rejected or reworked after an incorrect painting process.

The object forming the basis of the present invention is to realise a device to satisfy the above-outlined needs.

This task is solved according to the present invention in that the device described by way of introduction has been given the characterizing features as set forth in appended claim 1.

As a result of the present invention, it is possible very rapidly to measure exactly the flow in, for example, an air conduit. A gas volume is affected by both pressure and temperature. A flow of one litre in the compressed state is infinitely larger in the open air. It is possible to obviate hitherto found drawbacks with the aid of a device according to the present invention. Principally, it is necessary to provide for rapid regulation functions, and a device according to the present invention makes for the measurement of pressure extremely rapidly and exactly immediately upstream of a nozzle mouth or a discharge point, for example the air jet of a spraygun. Both air pressure and paint pressure are measured and regulated with the aid of a device according to the present invention. It is possible to control both the air pressure and the paint pressure in order to realise a controlled paint jet. In a device according to the present invention, the measurements are repeated approximately 1,000 times per second.

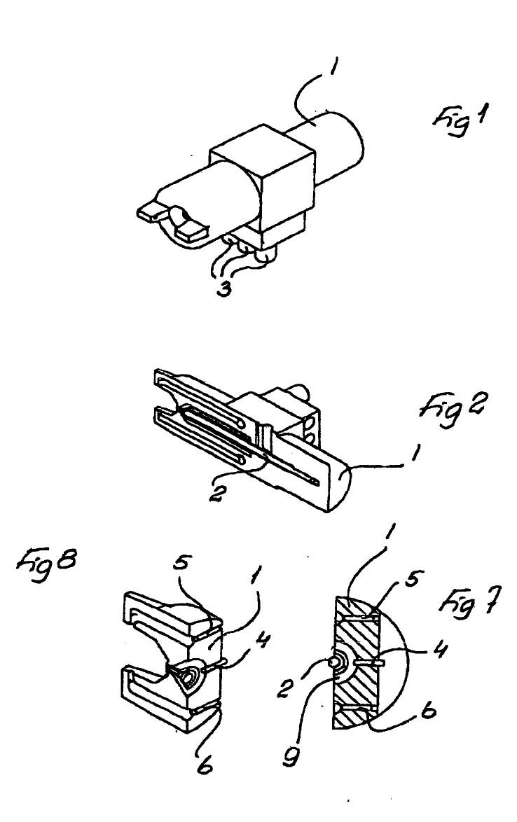

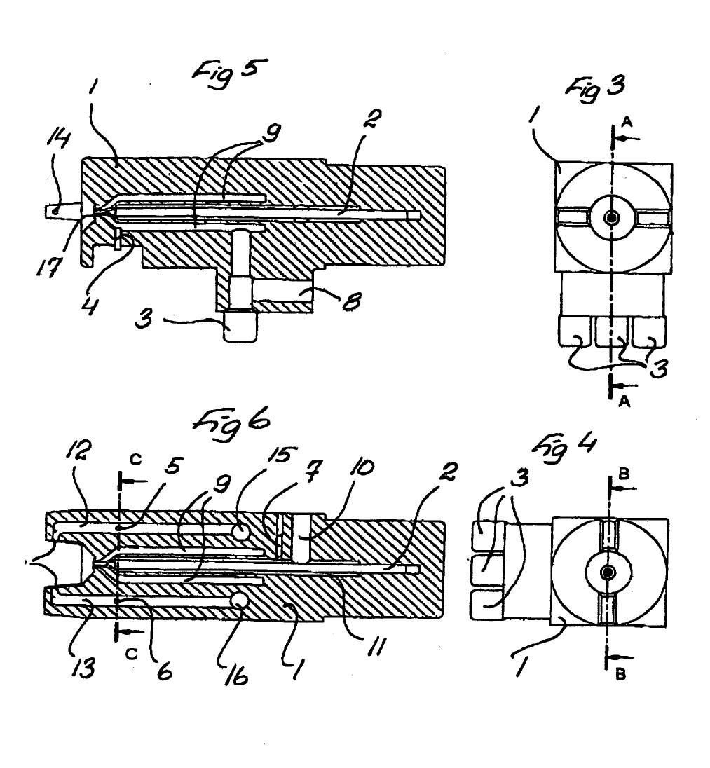

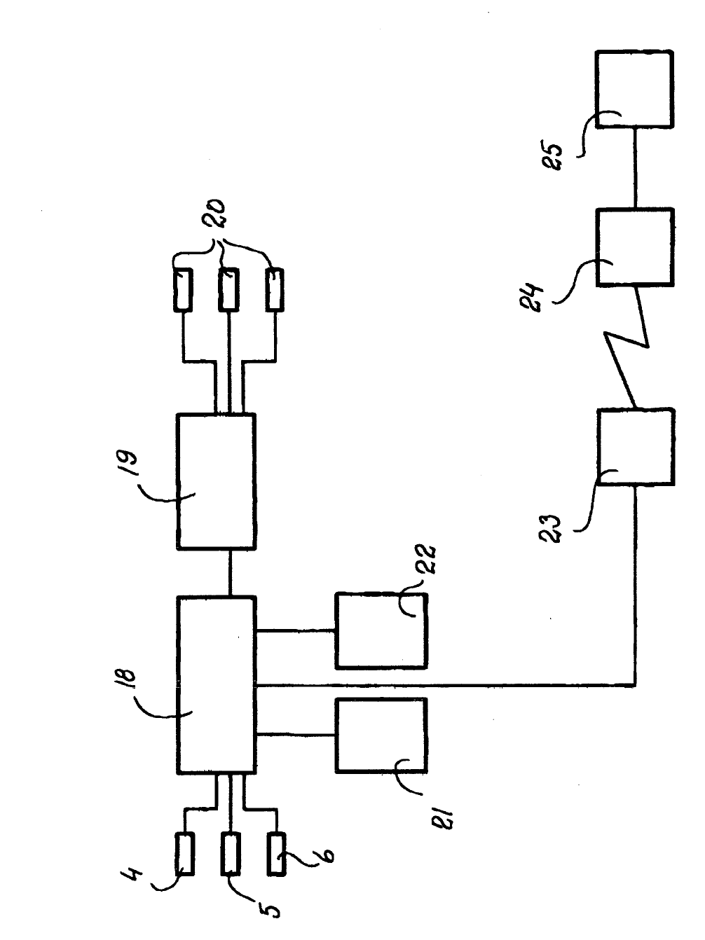

One embodiment of a device according to the present invention will be described in greater detail hereinbelow, with reference to die accompanying Drawings. FIG. 1 shows a perspective view of a spray nozzle with parts of a device according to the present invention. FIG. 2 shows a similar perspective view to that of FIG. 1 but divided along the longitudinal axis. FIG. 3 is an end elevation of the spray nozzle illustrated in FIGS. 1 and 2. FIG. 4 shows a substantially similar end elevation as that in FIG. 3. FIG. 5 shows a longitudinal section taken in the direction of the arrows A-A in FIG. 3. FIG. 6 shows a longitudinal section taken in the direction of the arrows B-B in FIG. 4. FIG. 7 shows a Section taken in the direction of the arrows C-C in FIG. 6. FIG. 8 is a perspective view of the part shown in FIG. 8 FIG. 9 is a block diagram of a device according to the present invention.

In the different Drawing FIGS. 1-8, a per se conventional painting gun or spraygun is exemplified which is modified and provided with parts of a device according to the present invention.

In the different Drawing figures, the same parts carry the same reference numeral. The spraygun or paint gun illustrated in FIGS. 1-8 is intended for painting an object, in which the spraygun is handled and manoeuvred by means of a robot arm.

The illustrated spraygun has a body 1 which includes a paint valve with a needle 2. The needle is operated on/off with the aid of a magnet or an air cylinder (not shown). The body 1 further displays a number of air valves 3. The illustrated embodiment of the body 1 has three valves 3, of which one is intended for a main function 14 and the two others each for their side jet 12, 13.

The body 1 further has a duct 9 for the main air or main function and the duct is cylindrical and passes around the paint duct with the needle valve 2. In addition, the body 1 has a duct 12 for right-hand side air and a duct 13 for left-hand side air. The ducts 12 and 13 are provided with outlet apertures 14 for the side air. An inlet channel is designated by reference numeral 15 for right-hand side air from its valve 3 and an inlet channel is designated by reference numeral 16 for left-hand side air from a valve 3. The nile aperture proper in the body 1 carries reference numeral 17 and is located at the end of the main channel 9. A paint inlet carries reference numeral 10, the paint flowing round the needle valve hole 2 up to the nozzle aperture 17. An air intake is designated by reference numeral 8, and it should be observed that, in FIG. 5, only the air intake for the main air to the main air duct 9 is shown.

A pressure indicator 4 discharges in the main air duct 9 in the proximity of the nozzle aperture 17 proper. The pressure indicator 4 is placed as close to the nozzle aperture 17 as possible. The right-hand side air duct 12 is provided with a pressure indicator 5 and the left-hand side air duct 13 is provided with a pressure indicator 6. The cylindrical paint duct 11 is also provided with a pressure indicator 7. The paint is not expandable and, as a result, the indicator 7 may be placed further away from the nozzle aperture 17 proper than the pressure indicator 4. The pressure indicators 4, 5, 6 and 7 may suitably be of per se known type and are available under the commercial name Kulit XCEL-xx-100-125 Bar A. The pressure indicators or pressure meters 4, 5, 6 and 7 are both small and quick-acting. The pressure indicators may be of the order of magnitude of 2 mm in diameter and a length of 10 mm (which in principle means 10 mm of a safety match).

The block diagram according to FIG. 9 shows only three pressure indicators or sensors, but it will be obvious to a person skilled in the art that any number whatever may be connected to an electronic circuit 18, which in turn includes a processor CPU and is connected to a number of control circuits 19 for regulating or controlling a number of valves 20. The number of valves 20 may suitably correspond to the number of pressure indicators 4, 5, 6 and 7 or sensors. The electronic circuit 18 is further provided with a memory 21 and a RTC circuit 22 which is a real time clock circuit. A communication circuit 23 also forms part of the electronic circuit and transfers signals to another communication circuit 24 with the aid of a suitable transfer technology method. e.g. IR or Blue Tooth, or some other known transfer technology. The communication circuit is suitably connected to a monitoring circuit which may be employed for a painting process.

It is also conceivable to connect several nozzles each with their pressure indicator to one and the same electronic circuit which, in such event, is naturally modified for handling pressure indicators from several nozzles.

As a result of the device according to the present invention, it is possible to make the process neural in such a manner that, at each individual spraying sequence she spray gun begins to operate a given time before being moved in over the workpiece. Such a starting operational phase can, with the device according to the present invention, be made more rapid, and thereby environmentally hazardous and costly “dry running” can be reduced or wholly obviated. In that the actual pressure is measured with the aid of the device according to the present invention at the point of consumption, a processor can, in the electronic circuit, rapidly discover when the process has pivoted in and thereby, once a number of parts have been painted, itself decide how many milliseconds before the part begins to be painted the spraygun must be stared. In a painted part, it is desirable to have regulated paint thickness throughout the entire part. This does not necessarily imply uniform thickness throughout the entire surface, but the paint thickness is determined by the use of the part. By controlling the process, the desired thickness can be regulated at every point of the part. Such control or regulation may be put into effect in different manners. The pressure of air and/or paint can be regulated or, for example, the movement of the spraygun over the workpiece may be modified. Thus, such modification may consist of the distance to the workpiece, the change in angle to the workpiece or the speed at which the spraygun is moved over the workpiece.

With a device according to the present invention, it is possible to execute measurements as rapidly as thousands or measurements per second. In the electronic circuit 18, there is a circuit for converting an analog signal to a digital signal and this so-called A/D converter is rehearsed to cater for several tens of thousands of conversions per second. The slowest process is pressure equalisation in air or gaseous medium. Consequently, it is of the utmost importance to measure as close to the point of consumption or the nozzle aperture 17 or outlet apertures 14 as possible.

During the painting process or control thereof, it is possible to transfer measurement values and store them in a computer medium in order later to be able to determine those parts which may possibly have deviated from the desired treatment. By such means, it is possible rapidly to discover and identity incorrectly treated parts. The plotting or registration of the measurement values is also important in order to be able to refine the process and provide information thereon in later inspection measurements in relation to an end result.

Using a device according to the plant invention, it is further possible to gather data in a low energy environment with the aid, for example, of battery power and thereafter transfer gathered data to peripheral equipment with the aid of per se known technology, for example IR or Blue Tooth. It is hence possible to have as little electrical equipment as possible in the spraying area itself, since this is often an environment when explosion is a hazard.

1. A device in a nozzle for monitoring and/or regulating of gas or liquid occurring in one or more ducts in the nozzle, or mixtures of one or more gases and/or one or more liquids, for example air and paint, in a spray gun for a painting plant, characterised in that a pressure indicator is mounted in the proximity of the end of that duct in the channel which is intended for the gas or liquid or mixture which is to be monitored and/or regulated, and is connected to an electronic circuit for generating a signal corresponding to the pressure prevailing in the duct and that the electronic circuit is connected to a circuit for regulating one or more valves for adjusting the measured pressure to a desired norm value.

2. The device as claimed in claim 1, in which the nozzle has one liquid duct and a number of gas ducts, characterised in that both the liquid duct and a number of gas ducts are provided with a pressure indicator; and that the pressure indicators are connected to the electronic circuit which is connected to a valve for each duct with pressure indicator for adjusting the pressure in the duct to the desired norm value.

3. The device as claimed in claim 1, characterised in that the electronic circuit includes a circuit for converting an analog signal to a digital signal.

4. The device as claimed in claim 1, characterised in that the electronic circuit includes a processor (CPU) for executing thousands of measurements per second for realizing as exact and rapid a regulation as possible.

5. The device as claimed in claim 4, characterised in that the electronic circuit is rehearsed to store the measurement values in a data medium for later monitoring and evaluation.

6. The device as claimed in claim 1, characterised in that the electronic circuit includes a low energy or battery section in the immediate proximity of the nozzle proper from which section the measurement values are transferred to peripheral equipment with the aid of a per se known transfer technology for example IR or Blue Tooth.

7. The device as claimed in claim 2, characterised in that the electronic circuit includes a circuit for converting an analog signal to a digital signal.

8. The device as claimed in claim 2, characterised in that the electronic circuit includes a processor (CPU) for executing thousands of measurements per second for realizing as exact and rapid a regulation as possible.

9. The device as claimed in claim 3, characterised in that the electronic circuit includes a processor (CPU) for executing thousands of measurements per second for realizing as exact and rapid a regulation as possible.

10. The device as claimed in claim 2, characterised in that the electronic circuit includes a low energy or battery section in the immediate proximity of the nozzle proper from which section the measurement values are transferred to peripheral equipment with the aid of a per se known transfer technology for example IR or Blue Tooth

11. The device as claimed in claim 3, characterised in that the electronic circuit includes a low energy or battery section in the immediate proximity of the nozzle proper from which section the measurement values are transferred to peripheral equipment with the aid of a per se known transfer technology for example IR or Blue Tooth

12. The device as claimed in claim 4, characterised in that the electronic circuit includes a low energy or battery section in the immediate proximity of the nozzle proper from which section the measurement values are transferred to peripheral equipment with the aid of a per se known transfer technology for example IR or Blue Tooth

13. The device as claimed in claim 5, characterised in that the electronic circuit includes a low energy or battery section in the immediate proximity of the nozzle proper from which section the measurement values are transferred to peripheral equipment with the aid of a per se known transfer technology for example IR or Blue Tooth.
